(19) United States
(12) Patent Application Publication
(10) Pub. No.: US 2016/0078289 A1
(43) Pub. Date: Mar. 17, 2016

(54) Gesture Recognition Apparatuses, Methods and Systems for Human-Machine Interaction

(71) Applicant: Foundation for Research and Technology - Hellas (FORTH) acting through its Institute of Computer, Heraklion (GR)

(72) Inventors: Damien Michel, Heraklion (GR); Konstantinos Papoutsakis, Heraklion (GR); Antonis Argyros, Heraklion (GR)

(73) Assignee: Foundation for Research and Technology - Hellas (FORTH) (acting through its Institute of Computer, Heraklion (GR)

(21) Appl. No.: 14/855,531

(22) Filed: Sep. 16, 2015

Related U.S. Application Data
(60) Provisional application No. 62/051,271, filed on Sep. 16, 2014.

(51) Int. Cl. G06K 9/00; G06K 9/46; G06K 9/62; G06K 9/52; G06T 7/60; G06T 7/20; G06F 3/01; G06T 7/00

(52) U.S. Cl. CPC G06K 9/00355; G06F 3/017; G06K 9/4609; G06T 7/0085; G06T 7/0051; G06K 9/52; G06T 7/60; G06T 7/2033; G06K 9/6202; G06T 7/0042; G06T 2207/30196

(57) ABSTRACT

The GESTURE RECOGNITION APPARATUSES, METHODS AND SYSTEMS FOR HUMAN-MACHINE INTERACTION (“GRA”) discloses vision-based gesture recognition. GRA can be implemented in any application involving tracking, detection and/or recognition of gestures or motion in general. Disclosed methods and systems consider a gestural vocabulary of a predefined number of user specified static and/or dynamic hand gestures that are mapped with a database to convey messages. In one implementation, the disclosed systems and methods support gesture recognition by detecting and tracking body parts, such as arms, hands and fingers, and by performing spatio-temporal segmentation and recognition of the set of predefined gestures, based on data acquired by an RGBD sensor. In one implementation, a model of the hand is employed to detect hand and finger candidates. At a higher level, hand posture models are defined and serve as building blocks to recognize gestures

### CROSS-REFERENCE TO RELATED APPLICATIONS

This application claims the benefit of U.S. Provisional Application No. 62/051,271, filed Sep. 16, 2014, and U.S. Provisional Application No. 62/053,667, filed Sep. 22, 2014, both of which are incorporated by reference in their entireties as if fully set forth herein.

### FIELD

The present subject matter is directed generally to apparatuses, methods, and systems of detection, tracking, and/or recognition of motion or motion, and more particularly, to GESTURE RECOGNITION APPARATUSES, METHODS AND SYSTEMS FOR HUMAN-MACHINE INTERACTION (“GRA”).

### RELATED ART

Vision-based gesture recognition is aimed at recognizing meaningful physical movements that are performed by humans, through the processing and analysis of visual information acquired by a camera system. In recent years, this has been a highly active research area which, in many cases, has been of a multidisciplinary nature. The significant research efforts devoted to the problem have been motivated by wide-ranging applications in many commercial and business domains that can benefit from a robust solution.

Besides being interesting, the problem exhibits significant difficulties. Gestures can be of varying complexity and their recognition is also affected by the scene context, actions that are performed in the fore- or the back-ground at the same time, as well as by preceding and/or following actions. Moreover, gestures are often language- and culture-specific, providing additional evidence to substantiate the interesting as well as challenging nature of the problem.

According to a review by Aggarwal et. al (Aggarwal, J., Ryoo, M.: Human activity analysis: A review. ACM Comput. Surv. 43 (2011) 16:1-16:43) on the broader area of human activity recognition, human activities can be conceptually categorized into four different levels depending on their complexity: gestures, actions, interactions, and group activities. Gestures are defined as elementary movements of a person's body part, most commonly involving the hands, arms, face, head, defining the expressive atomic components that describe the meaningful motion of a person. Gestures can be static or dynamic, while some gestures also have both static and dynamic elements, as in sign languages. (see, e.g., Bowden, R., Zisserman, A., Kadir, T., Brady, M.: Vision based interpretation of natural sign languages. In: ICVS, ACM Press (2003)). Subsequently, actions are single person activities that may be composed of multiple gestures organized temporally, such as “walking”, “waving”, and “punching”. More resources on vision-based action recognition (e.g., Poppe, R.: A survey on vision-based human action recognition. Image and Vision Computing 28 (2010) 976-990), human motion analysis (e.g., Moeslund, T., Hilton, A., Krüger, V., Sigal, L.: Visual Analysis of Humans: Looking at People. SpringerLink: Bücher. Springer (2011)) and hand pose estimation (e.g., Erol, A., Bebis, G., Nicolescu, M., Boyle, R., X. Twombly: Vision-based hand pose estimation: A review. Computer Vision and Image Understanding, Special Issue on Vision for HCI 108 (2007) 52-73) are available in the literature.

Early techniques employed HMMs (e.g., Bowden, R., Zisserman, A., Kadir, T., Brady, M.: Vision based interpretation of natural sign languages. In: ICVS, ACM Press (2003)), Neural Networks (e.g., Yang, M. H., Ahuja, N.: Extraction and classification of visual motion patterns for hand gesture recognition. In: IEEE CVPR. (1998)), Kalman and particle filtering (e.g., Bretzner, L., Laptev, I., Lindeberg, T.: Hand gesture recognition using multi-scale colour features, hierarchical models and particle filtering. In: IEEE Automatic Face and Gesture Recognition. (2002)) to efficiently model the hand, estimate its pose and recognize static and dynamic gestures. A real-time implementation of gesture recognition for robot control was developed in (Ramamoorthy, A., Vaswani, N., Chaudhury, S., Banerjee, S.: Recognition of dynamic hand gestures. Pattern Recognition (2003)) combining skin color-based, shape-based recognition and Kalman-filtering for hand detection and tracking, while HMMs are used for temporal segmentation of hand gestures. The work in (Yoon, H. S., Soh, J., Bae, Y. J., Yang, H. S.: Hand gesture recognition using combined features of location, angle and velocity. Pattern Recognition (2001)) uses similar tools introducing the notion of a HMM codebook towards gesture recognition. A noteworthy technique regards the Finite State Machine (FSM) which models a gesture as a sequence of states in temporal order capturing also the semantics of the movements. It is used in many methodologies (e.g., Jo, K. H., Kuno, Y., Shirai, Y.: Manipulative hand gesture recognition using task knowledge for human computer interaction. In: IEEE International Conference on Automatic Face and Gesture Recognition. (1998)) to model and analyze simple, complex or manipulative gestures in the spatio-temporal configuration space. A recent method by Baraldi et.al (Baraldi, L., Paci, F., Serra, G., Benini, L., Cucchiara, R.: Gesture recognition in ego-centric videos using dense trajectories and hand segmentation. In: IEEE CVPR Workshops. (2014)) in the context of the emerging field of ego-centric vision, combines gesture recognition and hand segmentation, modeling both static and dynamic gestures as a collection of dense trajectories extracted around the detected hand regions.

Other methods rely on extracted 3D trajectories or angles of body joints and/or segmented gestures, concentrating in the classification task. In the work of Raptis et al. (Raptis, M., Kirovski, D., Hoppe, H.: Real-time classification of dance gestures from skeleton animation. In: Proceedings of the 2011 ACM SIGGRAPH/Eurographics. SCA '11 (2011)), a classification scheme is designed and trained, based on a novel angular skeletal representation of body motion acquired using the Kinect™ platform, in order to recognize from among 28 gesture classes in real-time, in the context of dancing.

Most recent advancements introduce the concept of personalized gesture recognition as a means to resolve some of the difficulties in the domain. They focus on the interpretation and assignment of the gestures to meaningful user-level system commands, which is a crucial task in order to achieve efficient natural-based interactivity between humans and computers. However, they require an additional process in order to collect personalization data and optimize the performance of the system. In many cases a training procedure (e.g., Fothergill, S., Mentis, H., Kohli, P., Nowozin, S.: Instructing people for training gestural interactive systems. In: SIGCHI Conference on Human Factors in Computing Systems. CHI '12 (2012)) is required to be performed by each user in order for a gestural interactive system to collect data and train a learning-based methodology to finally adapt its performance to the individual. In the same context, a learning-based methodology for personalization was recently proposed by Yao et.al (Yao, A., Van Gool, L., Kohli, P.: Gesture recognition portfolios for personalization. IEEE CVPR (2014)). Unlike other personalization methods (e.g., Zhang, C., Hamid, R., Zhang, Z.: Taylor expansion based classifier adaptation: Application to person detection. In: IEEE CVPR. (2008)) which learn a single classifier that later gets adapted, their approach learns a set (portfolio) of classifiers during training, one of which is selected for each test subject based on the personalization data.

### SUMMARY

A processor-implemented method for gesture recognition, the method includes receiving at least two temporally spaced RGBD frames depicting a gesture from a camera. For each received frame, a depth-based edge map is calculated based on comparing distances between adjacent pixel depth values in the received frame to a predetermined threshold distance. For each received frame, a binary image map is produced based on the depth-based edge map. For each received frame, a skeleton of the binary image map is computed. For each received frame, at least one hand hypothesis is identified by analyzing the skeleton. Finally, a gesture is recognized by comparing hand hypotheses identified for the at least two received frames.

In another embodiment, for each received frame, a contour map is computed based on the depth-based edge map, and the binary image map produced for each frame is produced based on the contour map.

In another embodiment, analyzing the skeleton to identify hand hypotheses includes computing spanning trees from the skeleton and traversing the spanning tree from a leaf node toward another leaf node so long as a spanning tree node does not exceed a predetermined hand size threshold.

In another embodiment, recognizing a gesture by comparing hand hypotheses includes identifying a hand posture from each of the hand hypotheses identified for the at least two received frames.

In another embodiment, identifying a hand posture includes, for each identified hand hypothesis, identifying orientations of at least a wrist, an index finger, and a thumb of the hand hypothesis and comparing the identified orientations to a predetermined set of hand posture identification rules.

In another embodiment, recognizing a gesture by comparing hand hypotheses includes, for each identified hand hypothesis, identifying the location of a palm center of the hand hypothesis.

In another embodiment, recognizing a gesture by comparing hand hypotheses includes recognizing movement of a hand hypothesis from one received frame to another and comparing the recognized movement to a predetermined set of gesture movement rules.

### BRIEF DESCRIPTION OF THE DRAWINGS

The accompanying drawings illustrate various non-limiting, example, inventive aspects in accordance with the present disclosure:

FIG. 1 is a subset of the gestures supported by GRA, according to an implementation of the present subject matter;

FIG. 2 is an exemplary illustration of the intermediate results of hand detection as implemented by GRA, according to an implementation of the present subject matter; and

FIG. 3 is a block diagram illustrating embodiments of the GRA controller, according to an implementation of the present subject matter.

FIG. 4 is a view of a 2D hand model utilized to detect hand candidates.

FIG. 5 is a table depicting exemplary rules used to assign hand hypotheses to posture classes based on the values of the hand model parameters.

FIGS. 6-22 are an illustration of a series of screenshots showing experiments performed using GRA.

FIG. 23 is a table that shows the confusion matrices for the classification experiments for the two sets of users.

FIG. 24 is a table that reports the standard measures of statistical analysis for gesture classification.

FIG. 25 is a flow diagram of an exemplary body tracker.

FIG. 26 is a flow diagram of a body detection and tracking module of an exemplary body tracker.

FIG. 27 is a flow diagram of a limbs detection and tracking module of an exemplary body tracker.

FIG. 28 is a flow diagram of a hands detection and tracking module of an exemplary body tracker.

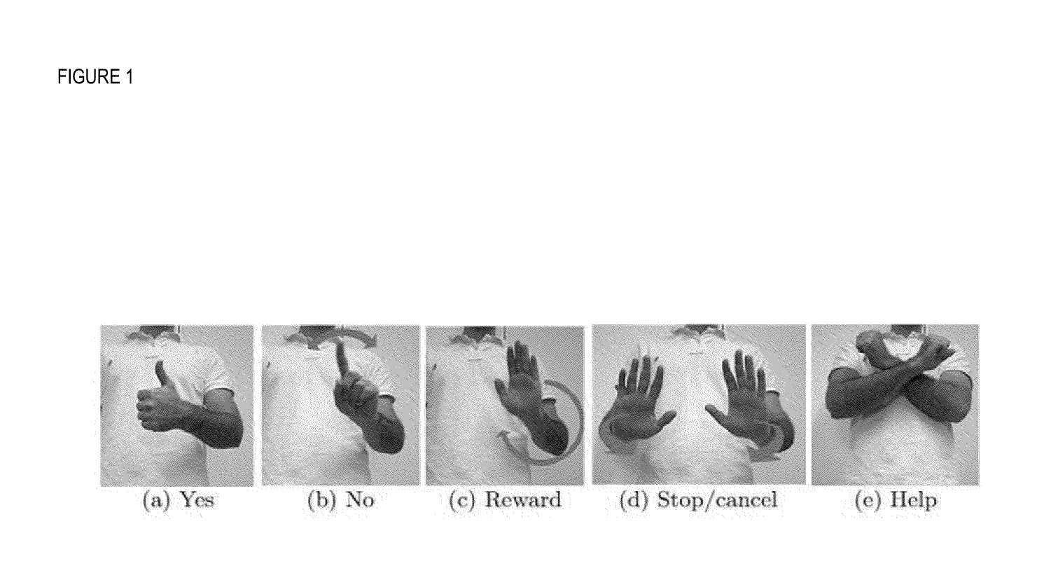

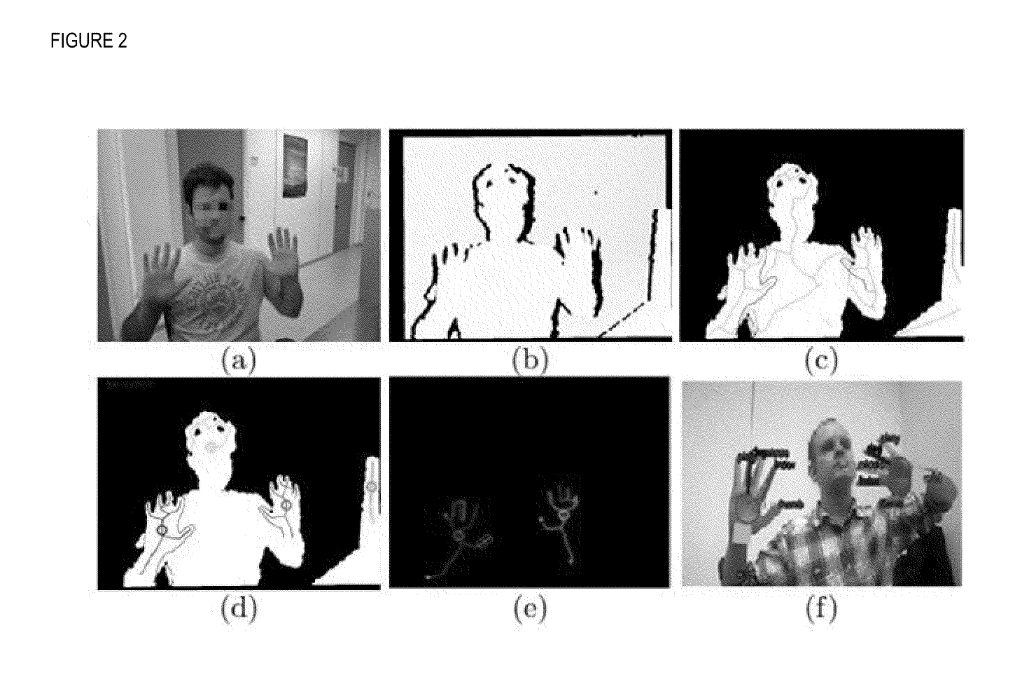

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

It should be appreciated by those skilled in the art that any block diagrams herein represent conceptual views of illustrative systems. Similarly, it should be appreciated that any flow charts, flow diagrams, state transition diagrams, pseudo code, and the like represent various processes, which may be substantially represented in a computer readable medium and so executed by a computer or processor, whether or not such computer or processor is explicitly shown.

### DETAILED DESCRIPTION

Embodiments of the GESTURE RECOGNITION APPARATUSES, METHODS AND SYSTEMS FOR HUMAN-MACHINE INTERACTION (“GRA”) offer vision-based gesture recognition to support, for example, robust and efficient human robot interaction towards developing socially assistive robots. In other implementations, the GRA can be implemented in any application involving tracking, detection or recognition of gestures, in particular, or motion, in general. According to an implementation, the exemplary methods and systems encompass a collection of techniques that enable robust, real-time and efficient gesture recognition based on visual information acquired by a camera, for example, a Red-Green-Blue-Depth (RGBD) camera. To achieve the recognition of the aforementioned gestures, detection and tracking of multiple hands and fingers is initially performed based, for example, on an effective layered representation of a hand model including the wrist, palm and fingers. In one implementation, temporal association of the computed hand candidates across time is also performed. By analyzing the available 3D trajectory and geometric properties of the fitted model for each hand candidate in the scene, segmentation and recognition of the gestural actions may additionally be performed.

The description and figures merely illustrate exemplary embodiments of the GRA. For example, the principles of the present subject matter could be implemented with a variety of sensors, camera arrangements, and planar or 3-D gestures. It will thus be appreciated that those skilled in the art will be able to devise various arrangements that, although not explicitly described or shown herein, embody the principles of the present subject matter. Furthermore, all examples recited herein are intended to be for pedagogical purposes only to aid the reader in understanding the principles of the present subject matter and the concepts contributed by the inventor(s) to furthering the art, and are to be construed as being without limitation to such specifically recited examples and conditions. The present subject matter is not limited to one field, and can be extended to cover applications where motion sensing technology is used, such as gaming, robotics, etc. Moreover, all statements herein reciting principles, aspects, and embodiments of the present subject matter, as well as specific examples thereof, are intended to encompass equivalents thereof. It will also be appreciated by those skilled in the art that the words, such as during, while, and when, as used herein, are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

In one implementation, the disclosed systems and methods support robust and natural interaction of a human and an autonomous socially assistive robot, enhancing multi-modal human-robot interaction. In other implementations, the disclosed methods and systems can be implemented in any application requiring tracking, detection or recognition of gestures, in particular, or any motion, in general.

In one implementation, the target user group includes people of all ages and variable familiarity with technology. Therefore, an intuitive set of gestures have been defined, conveying messages of fundamental importance in a dialogue, such as “Yes”, “No”, “Reward”, “Stop/Cancel” and “Help”. For example, these may be realized by a subject with a variety of finger, palm, and arm movements, as shown in FIG. 1.

Gestures are defined as static postures (“Yes”, “Help”), but also as temporally evolving, dynamic gestures (“No”, “Reward”, “Stop/Cancel”). The recognition of gestures depend on modeling and recognizing human body parts at different scales, e.g., from single-handed hand postures involving fingers (“No”), to bi-manual postures involving two arms (“Help”). In the quest for natural interaction, users defined gestures with intrinsic ambiguities. For example, the hand shape in “Yes” and “No” or in “Reward” and “Stop/cancel” are quite similar. In one implementation, the gestures can be recognized for a broad range of parameters related to the biometric characteristics of the subjects, their age, their mobility capabilities, the specific way they perform gestures, etc. In one implementation, the gestures can be recognized online, in continuous video streams. Therefore, in one implementation, they can be segmented and identified robustly in the context of other, arbitrary and un-modeled hand motions. In one implementation, the defined gestures need to be recognized by an assistive robot operating at a user's home. Therefore, in one implementation, the gestures are recognized by a potentially moving camera, in varying illumination conditions and with robustness to scene clutter.

FIG. 2 is an exemplary illustration of intermediate results for hand detection, where (a) represents an input RGB frame, (b) represents an input depth frame Iₜ, (c) represents the binary mask Mₜ where far-away structures have been suppressed and depth discontinuities of Iₜ appear as background pixels. Skeleton points Sₜ are shown superimposed (red pixels). (d) Represents a forest of minimum spanning trees is computed based on (c), identifying initial hand hypotheses. Circles represent the palm centers. (e) Represents checking hypotheses against a hand model facilitates the detection of the actual hands, filtering out wrong hypotheses. (f) Represents another example showing the detection results (wrist, palm, fingers) in a scene with two hands, according to an implementation of the present subject matter.

In one implementation, at each time instant t, an RGBD frame is acquired. An exemplary RGB frame is shown in FIG. 2(a) and an exemplary depth frame is shown in FIG. 2(b).

In one implementation, as a first processing step, a depth-based edge map Gₜ is calculated based at least on the data from one or more depth frames. A depth frame is denoted by Iₜ and an example is shown in FIG. 2(b). It is assumed that the intrinsic calibration data of the camera is available, enabling the conversion of the acquired depth pixels to a 3D point cloud representation. Let p=(i, j) be an image point and let N(p) denote the set of its eight immediate neighbors in its 3×3 neighborhood. A point Gₜ(p) is set as a depth edge point, if its 3D Euclidean distance to any of its neighbors is higher than a threshold value T_{D}. In notation,

$${G}_{t} ( p ) = \{ \begin{matrix}1 , & if {‖ {I}_{t} ( p ) - {I}_{t} ( {p}^{′} ) ‖}_{2} > {T}_{D} , ∀ {p}^{′} ε N ( p ) \\ 0 , & otherwise .\end{matrix} \qquad ( 1 )$$

Additionally or optionally, a contour map Cₜ may be computed to refine the edge map Gₜ. For example,

$${C}_{t} ( p ) = \{ \begin{matrix}1 , & if {\sum }_{{p}^{′} ε N ( p )} G ( {p}^{′} ) > 0 \\ 0 , & otherwise .\end{matrix} \qquad ( 2 )$$

Practically, a point p is considered as a contour point if at least one of its neighbors is a depth edge point.

A binary image map Mₜ may then be produced based on at least one of the contour map Cₜ and the depth-based edge map Gₜ. For example,

$${M}_{t} ( p ) = \{ \begin{matrix}1 , & if {I}_{t} ( p ) \leq {T}_{V} , {C}_{t} ( p ) = 0 \\ 0 , & otherwise .\end{matrix} \qquad ( 3 )$$

The intuition behind Mₜ is the following. A point in Mₜ is considered as back-ground (o) if its depth value is greater than a threshold Tᵥ, or if it is a depth discontinuity (C(p)=1). Essentially, this means that all distant scene points are considered irrelevant and further processing is restricted in a depth range defined by Tᵥ. Additionally, depth discontinuities appear as background pixels. In experiments, the distance thresholds T_{D} and Tᵥ are set to 30 mm and 1500 mm, respectively. An example map Mₜ is shown in FIG. 2(c).

In one implementation, as a final preprocessing step, the skeleton Sₜ of Mₜ is computed using, for example, morphological filtering. Let Sₜ denote a binary image where only skeletal points appear as foreground. Sₜ appears in FIG. 2(c) (red pixels superimposed on Mₜ). A different skeleton is identified for each of the connected components of the binary image map.

In one implementation, once St is computed, a forest of minimum weight spanning trees are computed (one spanning tree T for each skeleton). This is based on a graph representation of points of a skeleton. More specifically, two points of a specific skeleton are considered connected if their 3D distance is lower than a threshold that is set equal to 100 mm in the experiments. Otherwise, their distance is set equal to infinity.

In one implementation, based on the fact that candidate hands are more likely to be localized on the extremities (leafs) of each minimum spanning tree T, segmentation of each of the spanning trees by calculating optimal cut points and tree branches that correspond to hand structures. Searching for an optimal cut, a minimum spanning tree T is traversed starting from any of its leaf nodes towards any other leaf node, as long as the spanning tree nodes and the corresponding structure do not exceed the size of an average human hand (for example, 180 mm). In one implementation, several cuts may satisfy the described constraints, resulting in different overlapping trees. From each set of overlapping trees, the largest one, for example, is selected. The remaining trees constitute the initial hand hypotheses h. FIG. 2(d) shows four such identified hypotheses. As it can be verified, although all actual hands have been identified, false positives may exist.

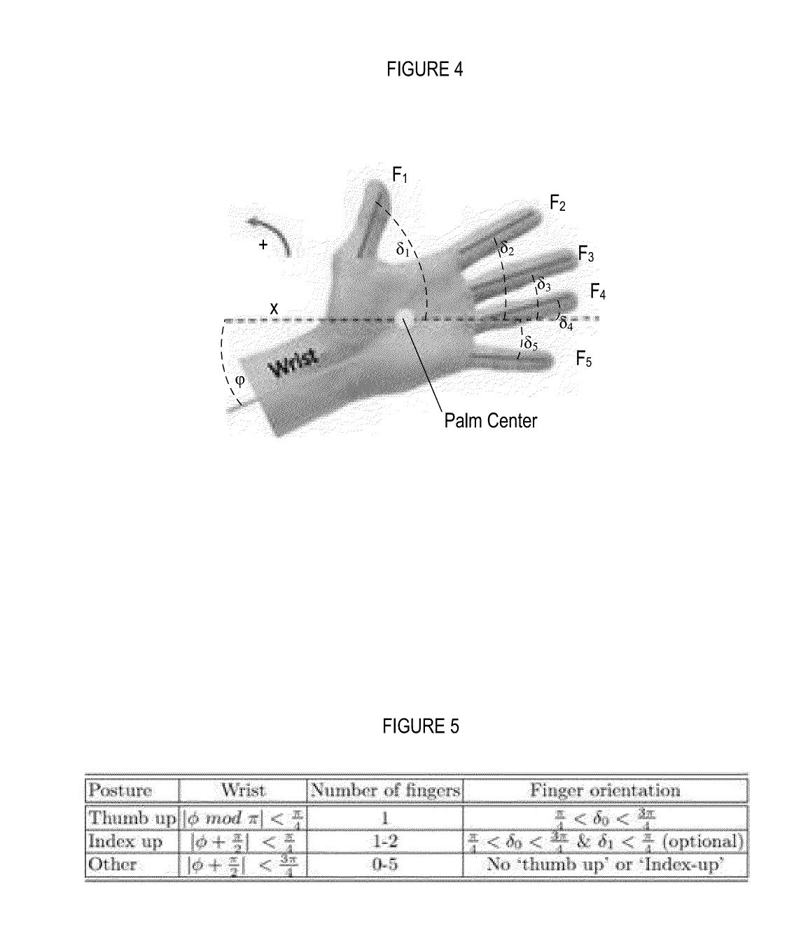

In one implementation, to filter-out wrong hand hypotheses, a 2D hand model that is compared against each of the computed hand hypotheses h is employed. The employed hand model consists of (a) a wrist region and its orientation, (b) a palm center and, (c) up to five fingers (see FIG. 4). The orientations δ₁ε[−π. . . π) of each finger and the orientation φε[−π. . . π) of the wrist are computed with respect to the x-axis of the camera coordinate system and are considered positive in the counterclockwise direction. These hand components are sequentially fit in each hand hypothesis.

In one implementation, the palm center of the hand candidate is estimated by finding the local maximum of the distance transformed Mₜ, in the region spanned by the hand hypothesis h. Intuitively, such a point is the center of a relatively large and compact area that matches closely the shape of a palm.

In one implementation, given the estimated palm center of each hand candidate, the positions and orientations of the finger candidates are computed. In one implementation, a skeletal shape descriptor K on the skeletal points of Sₜ. Each such descriptor consists of two components. The first is the local slope of the skeleton. Assuming that the descriptor is computer at a point p, this local slope is estimated by fitting a straight line to the skeleton points located within a radius of 5 pixels from p. The second component of the descriptor is the 3D Euclidean distance of p to the closest background point in Mₜ in a direction perpendicular to its local slope.

A finger candidate is localized by sequentially grouping skeletal descriptors K, starting from the skeletal point of hand hypothesis h that is closest to the palm center, towards its leaf nodes. This, in one implementation, is achieved by applying a set of geometric constraints that reflect the structural properties of the position and orientation of a finger candidate with respect to the palm center.

Based on the computed finger candidates, a set of additional features are also calculated with respect to the skeletal descriptors assigned to each finger. Those regard the center, direction, tip, root, and width of each finger. The center and direction are estimated by averaging the corresponding values of all descriptors, while the tip and the root are defined as the furthest and closest descriptors from the palm center, respectively. Subsequently, in one implementation, a finger candidate respects a set of constrains based on these feature values in order to be attached to the hand model. More specifically, the orientation of each finger is expected to be roughly towards the palm center, thereby the projection of the palm center pixel to the line defined by the finger center and the finger direction is considered. In one implementation, the finger candidate is considered as valid if the 3D distance between the center and its projection is less than the expected size of the palm.

If two or more fingers have been detected for a hand hypothesis, the position and orientation of its wrist is computed by fitting a 3D line to the skeletal points starting from the palm center, in a direction opposite to the fingers and up to a distance of, for example, 20 cm.

FIG. 2(e) shows that by employing the aforementioned techniques, the false hand hypotheses of FIG. 2(d) have been removed. FIG. 2(f) provides a similar example where sample, low level hand detection results are shown.

In one implementation, in order to track hands in time, a tracking-by-detection approach may be implemented. More specifically, the hands that are detected at time t are associated to the closest hands detected at time t−1. In this context, proximity is defined based on the 3D space covered by each hand hypothesis at each time t. Rules similar to the ones employed in the blob tracker presented in, e.g., (Argyros, A., Lourakis, M.: Real time tracking of multiple skin-colored objects with a possibly moving camera. In: IEEE ECCV. (2004) 368-379) are used to handle the introduction of a new hand and the disappearance of a tracked one.

In one implementation, a predetermined number of postures, such as three different hand postures, are defined and recognized, “Thumb up”, “Index up” and “Other”. At each time t each detected hand model (see FIG. 4) is classified against one of the posture classes by matching the feature values to the exemplary posture models shown in FIG. 5 following a best-fit classification scheme. The additional constraint φ+π2ε[−π, π) may be checked before the absolute value of the result is calculated and compared.

FIG. 1 is a subset of the gestures supported by GRA, according to an implementation of the present subject matter. As shown in the figure, the correspondence between gestures and physical actions of hands/arms are as follows: (a) Illustrates “Yes”: A “thumb up” hand posture. (b) Illustrates “No”: A sideways waiving hand with extended index finger. (c) Illustrates “Reward” or “Circle”: A circular motion of an open palm at a plane parallel to the image plane. (d) Illustrates “Stop/cancel”: A two-handed push forward gesture. (e) Illustrates “Help”: two arms in a cross configuration. It will be understood that this represents only an exemplary subset of the possible set of gestures. Other sets or variations of the gestures are possible and can be configured by the user or a programmer.

“Yes”: In one implementation, the case of the “Yes” gesture is recognized if the posture performed by a single tracked hand is classified as a “Thumb up” posture for a number F_{y} of consecutive frames. For example, Fₜᵤ is set to 10 in the experiments.

“No”: In one implementation, for the “No” gesture, a waving motion of the tip of the index finger is detected. Therefore, an “Index up” posture should be recognized for a number of consecutive frames. Additional constraints can then applied to the 3D trajectory of the finger tip for those frames. More specifically, its projection onto the x-axis of the camera coordinate system is computed. A smoothening is applied and the consecutive extremity values of the signal are assessed, which indicate the start and end points of the movement. The “No” gesture is recognized if there is a minimum Rₙ=4 repetitions of a sideways motion of the hand. The width of each sideways motion has to be at least 30 mm. By setting this minimum low, the recognition of the “No” gesture is possible even if only the index finger moves, while the palm remains practically static.

“Stop/Cancel”: In one implementation, the “Stop/Cancel” gesture regards the physical movement of both hands moving simultaneously towards the camera with open palms, as in FIG. 1(c). The 3D coordinates of the palm centers of both hands are considered. For example, they are at a similar distance from the camera at the beginning of the motion, and their trajectories should be mainly towards the camera plane, i.e., their distances to the camera plane can be strictly decreasing over more than 100 mm. During the whole gesture, the depth difference of the two palm centers has to be less than 100 mm.

“Reward/Circle”: In one implementation, the “Reward” gesture is realized using each of the hands to perform a circular motion with open palm facing the camera. The 3D coordinates of the center of the performing hand are orthogonally projected onto the 2D camera plane. Subsequently, an ellipse is fitted based on the induced 2D coordinates and their angle is assessed with respect to the center of the ellipse. In one implementation, if the angle is continuously increasing (or decreasing) over more than 360 degrees, a “Reward” gesture is triggered.

“Help”: In one implementation, the “Help” gesture is triggered upon successful detection of a pair of hands. The absolute value of the angle formed by the two wrist directions has to be in the interval [π/2±π/4]. The line joining the two hand centers are, e.g., roughly parallel to the horizon (orientation less than π/4) and the intersection point of the wrist lines has to be below the centers. If these conditions are satisfied for more than Fₕ=10 consecutive frames, the gesture is validated.

The order in which both the various methods described herein is not intended to be construed as a limitation, and any number of the described method steps can be combined in any order to implement the methods, or an alternative method. Additionally, individual steps may be deleted from or added to the methods described herein without departing from the spirit and scope of the subject matter described herein. Furthermore, the methods can be implemented in any suitable hardware, software, firmware, or combination thereof. The methods may also be taught to a user through written, pictographic, audio or audiovisual instructions.

It will be recognized that applications of the GRA are not limited to hand-related configurations, but can also be used to track, encode, and transmit information regarding motions of other parts of the body, such as the legs, feet, arms, neck, and head. As an example, applications of the GRA go beyond the use of interaction with socially assistive robotic arrangements, but can also be used for applications such as gaming, or even for automated range-of-motion tracking for physical therapy patients who may be recovering from injury accidents that cause limited mobility. In one embodiment, a single physical therapist may be able to monitor the progress of many patients simultaneously, more accurately, and in a way that allows for issuing and storing alerts when motion thresholds are exceeded.

In another embodiment, the gestures detection algorithm described herein may be fully integrated with a body tracker. In this embodiment, the basic functionality remains the same, which is the detection of a restricted set of hand/arm gestures. However, the supplementary information provided by the body tracker improves the overall performance (elimination of false positive and better detection rate), especially for dual arms gestures. The main interest remains in the ability to run both the body tracker and gestures detection on the same low level data, for a very small computational overhead.

In one example of this embodiment, the gestures detection algorithm relies on a body tracker to perform most of the preprocessing. One example of a body tracker is disclosed in U.S. Provisional Application No. 62/053,667, which is incorporated by reference in its entirety as if fully set forth herein. The body tracker provides (a) finger candidates: the body tracker extract these in a very similar manner as the previous gestures implementation did, and are used the same way and (b) elbow and wrist 3d position: previously, after the estimation of the palm center, a rough direction of the arm was also estimated. The palm center may be estimated in a similar manner (wrist and fingers provide a rough initial position), but the wrist-elbow line may provide a better estimate of the arm direction, and suffer less from local occlusions (crossed arms). These are then filtered, and combined into the basic hands models, on which the postures are evaluated. The rest of the process described above remains unchanged.

A compatible body tracker may also include the functionality of detecting and tracking human legs and human hands, and in particular palms and fingers.

FIG. 25 is a flow diagram of an exemplary body tracker. In one example of a body tracker, the body tracker may be divided into three main modules, each performing sequentially detection and tracking of the main body (torso and head, module B), the limbs (arms and legs, module L), and the hands (module H). They take as an input the RGBD frame, the previous pose of the body if available, and the output P(t−1) of the estimation at the previous time instance, t−1.

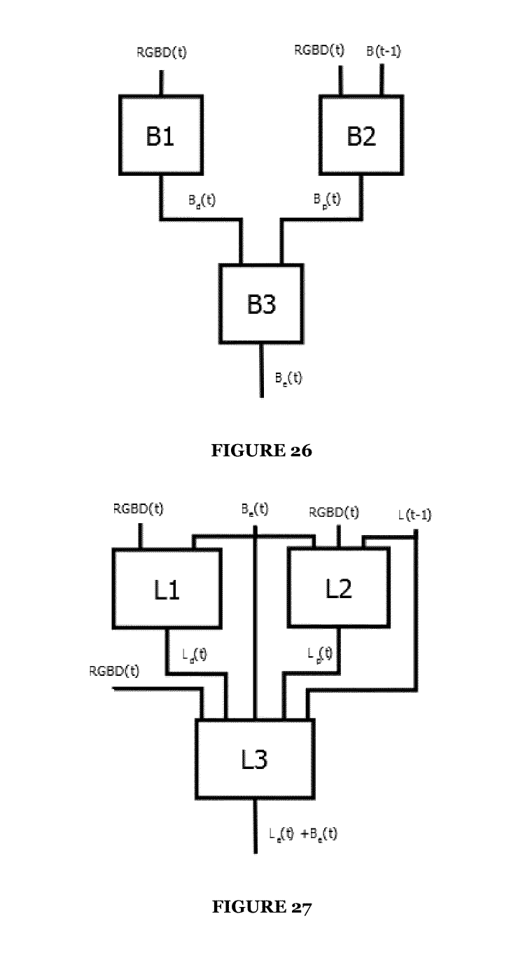

FIG. 26 is a flow diagram of a body detection and tracking module (module B) of an exemplary body tracker. B1 performs detection of the body at time t, B2 propagates the previous guess B(t−1) to the current frame and B3 fuses the two guesses.

FIG. 27 is a flow diagram of a limbs detection and tracking module (module L) of an exemplary body tracker. L1 gives a set of single shot detection guesses for each limb, L2 progates the limbs of the previous frame, and L3 select the best compatible combination of guesses for each limb. L1 and L2 can further be divided each into two modules, for the legs and the arms.

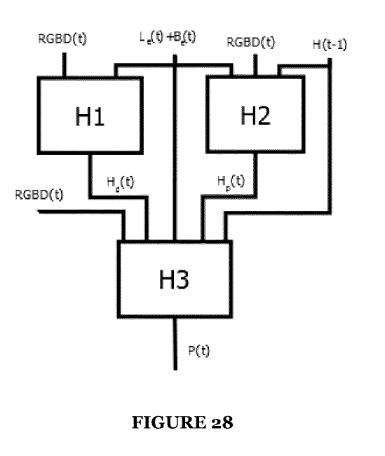

FIG. 28 is a flow diagram of a hands detection and tracking module (module H) of an exemplary body tracker. H1 and H2 give respectively detection and propagation guesses, for each arm given by the module L. H3 selects the most likely hand hypotheses and then combines and refines all the results to create the final guess for the body pose.

### GRA Controller

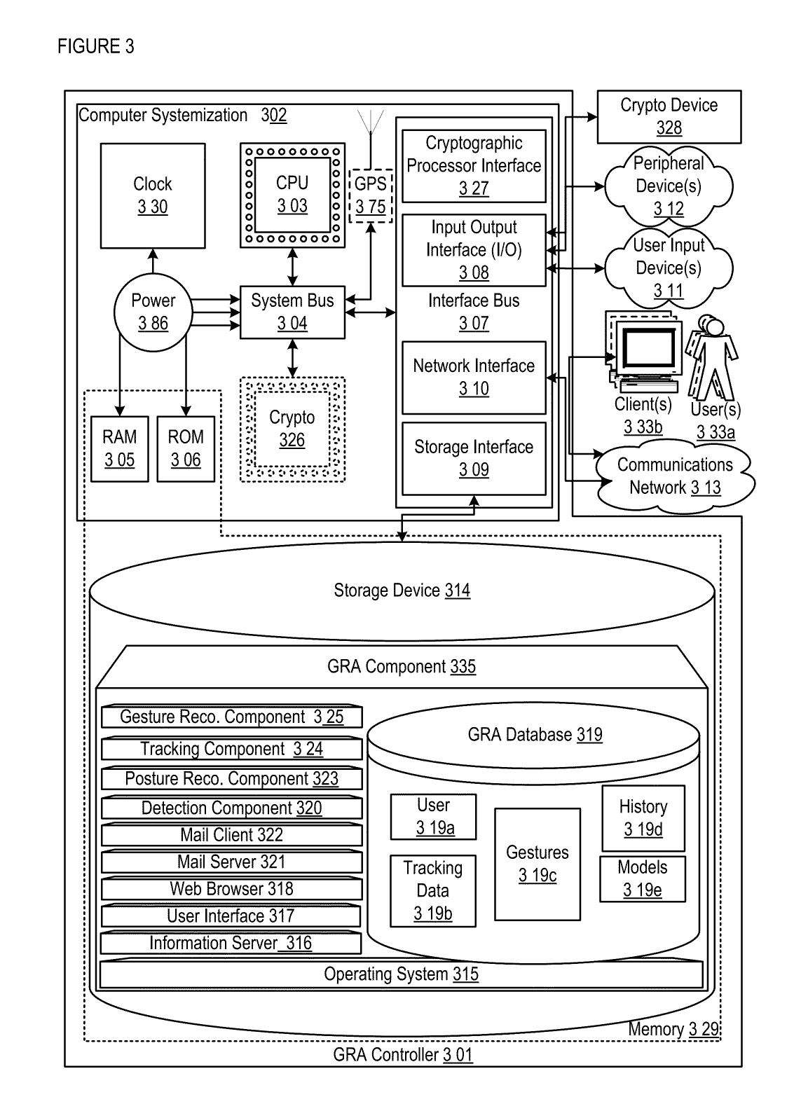

FIG. 3 is an exemplary illustration of inventive aspects of a GRA controller 201 in a block diagram. In this embodiment, the GRA controller 201 may serve to aggregate, process, store, search, serve, identify, instruct, generate, match, and/or facilitate interactions with a computer through user-selected information resource collection generation and management technologies, and/or other related data.

Typically, users, which may be people and/or other systems, may engage information technology systems (e.g., computers) to facilitate information processing. In turn, computers employ processors to process information; such processors 303 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the GRA controller 201 may be connected to and/or communicate with entities such as, but not limited to: one or more users from user input devices 311; peripheral devices 312; an optional cryptographic processor device 328; and/or a communications network 313.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The GRA controller 301 may be based on computer systems that may comprise, but are not limited to, components such as: a computer systemization 202 connected to memory 329.

### Computer Systemization

A computer systemization 302 may comprise a clock 330, central processing unit (“CPU(s)” and/or “processor(s)” (these terms are used interchangeable throughout the disclosure unless noted to the contrary)) 303, a memory 329 (e.g., a read only memory (ROM) 306, a random access memory (RAM) 305, etc.), and/or an interface bus 307, and most frequently, although not necessarily, are all interconnected and/or communicating through a system bus 304 on one or more (mother)board(s) 302 having conductive and/or otherwise transportive circuit pathways through which instructions (e.g., binary encoded signals) may travel to effect communications, operations, storage, etc. Optionally, the computer systemization may be connected to an internal power source 386. Optionally, a cryptographic processor 326 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the GRA controller and beyond through various interfaces. Should processing requirements dictate a greater amount speed and/or capacity, distributed processors (e.g., Distributed GRA), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the GRA may be achieved by implementing a microcontroller such as CAST's R8051XC2 microcontroller; Intel's MCS 51 (i.e., 8051 microcontroller); and/or the like. Also, to implement certain features of the GRA, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the GRA component collection (distributed or otherwise) and/or features may be implemented via the microprocessor and/or via embedded components; e.g., via ASIC, coprocessor, DSP, FPGA, and/or the like. Alternately, some implementations of the GRA may be implemented with embedded components that are configured and used to achieve a variety of features or signal processing.

Depending on the particular implementation, the embedded components may include software solutions, hardware solutions, and/or some combination of both hardware/software solutions. For example, GRA features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the GRA features. A hierarchy of programmable interconnects allow logic blocks to be interconnected as needed by the GRA system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the GRA may be developed on regular FPGAs and then migrated into a fixed version that more resembles ASIC implementations. Alternate or coordinating implementations may migrate GRA controller features to a final ASIC instead of or in addition to FPGAs. Depending on the implementation all of the aforementioned embedded components and microprocessors may be considered the “CPU” and/or “processor” for the GRA.

### Power Source

The power source 386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 386 is connected to at least one of the interconnected subsequent components of the GRA thereby providing an electric current to all subsequent components. In one example, the power source 286 is connected to the system bus component 304. In an alternative embodiment, an outside power source 386 is provided through a connection across the I/O 308 interface. For example, a USB and/or IEEE 1394 connection carries both data and power across the connection and is therefore a suitable source of power.

### Interface Adapters

Interface bus(ses) 307 may accept, connect, and/or communicate to a number of interface adapters, conventionally although not necessarily in the form of adapter cards, such as but not limited to: input output interfaces (I/O) 308, storage interfaces 309, network interfaces 310, and/or the like. Optionally, cryptographic processor interfaces 327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 309 may accept, communicate, and/or connect to a number of storage devices such as, but not limited to: storage devices 214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 310 may accept, communicate, and/or connect to a communications network 313. Through a communications network 313, the GRA controller is accessible through remote clients 333b (e.g., computers with web browsers) by users 333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed GRA), architectures may similarly be employed to pool, load balance, and/or otherwise increase the communicative bandwidth required by the GRA controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 310 may be used to engage with various communications network types 313. For example, multiple network interfaces may be employed to allow for the communication over broadcast, multicast, and/or unicast networks.

Input Output interfaces (I/O) 308 may accept, communicate, and/or connect to user input devices 311, peripheral devices 212, cryptographic processor devices 328, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 311 may be card readers, dongles, finger print readers, gloves, graphics tablets, joysticks, keyboards, mouse (mice), remote controls, retina readers, trackballs, trackpads, and/or the like.

Peripheral devices 312 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the GRA controller may be embodied as an embedded, dedicated, and/or monitor-less (i.e., headless) device, wherein access would be provided over a network l interface connection.

Cryptographic units such as, but not limited to, microcontrollers, processors 326, interfaces 327, and/or devices 328 may be attached, and/or communicate with the GRA controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 329. However, memory is a fungible technology and resource, thus, any number of memory embodiments may be employed in lieu of or in concert with one another. It is to be understood that the GRA controller and/or a computer systemization may employ various forms of memory 329. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 329 will include ROM 306, RAM 305, and a storage device 314. A storage device 314 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 329 may contain a collection of program and/or database components and/or data such as, but not limited to: operating system component(s) 315 (operating system); information server component(s) 316 (information server); user interface component(s) 317 (user interface); Web browser component(s) 318 (Web browser); database(s) 319; mail server component(s) 321; mail client component(s) 322; detection component 320 (cryptographic server); posture recognition (Reco) component 323; tracking component 324; gesture recognition component 325; the GRA component(s) 335; the other components such as mapping components (not shown), and/or the like (i.e., collectively a component collection). These components may be stored and accessed from the storage devices and/or from storage devices accessible through an interface bus. Although non-conventional program components such as those in the component collection, typically, are stored in a local storage device 314, they may also be loaded and/or stored in memory such as: peripheral devices, RAM, remote storage facilities through a communications network, ROM, various forms of memory, and/or the like.

### Operating System

The operating system component 315 is an executable program component facilitating the operation of the GRA controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the GRA controller to communicate with other entities through a communications network 313. Various communication protocols may be used by the GRA controller as a subcarrier transport mechanism for interaction, such as, but not limited to: multicast, TCP/IP, UDP, unicast, and/or the like.

### Information Server

An information server component 316 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the GRA controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the GRA database 319, operating systems, other program components, user interfaces, Web browsers, and/or the like.

Access to the GRA database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the GRA. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the GRA as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM'sOS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 317 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 318 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the GRA enabled nodes. The combined application may be nugatory on systems employing standard Web browsers.

### Mail Server

A mail server component 321 is a stored program component that is executed by a CPU 303. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the GRA.

Access to the GRA mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 322 is a stored program component that is executed by a CPU 303. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 320 is a stored program component that is executed by a CPU 303, cryptographic processor 326, cryptographic processor interface 327, cryptographic processor device 328, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the GRA may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the GRA component to engage in secure transactions if so desired. The cryptographic component facilitates the secure accessing of resources on the GRA and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The GRA Database

The GRA database component 319 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the GRA database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the GRA database is implemented as a data-structure, the use of the GRA database 319 may be integrated into another component such as the GRA component 335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 319 includes several tables 319a-e. A user accounts table 19a may include fields such as, but not limited to: user_id, name, contact_info, account_identifier, parent_account_identifier, market participant_id, login, password, private_key, public_key, user_interface_interactions, content_ID, ad_ID, device_ID, and/or the like. The user table may support and/or track users interfacing or interacting with the GRA controller 301. A tracking data table 319b may include fields such as, but not limited to: binarymask_data, depth_Frame_Data, skeleton_point_Data, and/or the like. A Gestures table 319c may include fields such as, but not limited to: gesture_type, gesture_name, and/or the like. A history table 319d may include historical data from past interactions stored in fields such as, but not limited to: history_timestamp, history_parameters, and/or the like. This data may be accessed to better the knowledge base and/or explore areas of improvement. A models table 319e may include fields such as, but not limited to: model_type, model_hand, model_finger, model_palm, model_Variables, model_parameters, and/or the like.

In one embodiment, the GRA database may interact with other database systems. For example, employing a distributed database system, queries and data access by search GRA component may treat the combination of the GRA database, an integrated data security layer database as a single database entity.

In one embodiment, user programs may contain various user interface primitives, which may serve to update the GRA. Also, various accounts may require custom database tables depending upon the environments and the types of clients the GRA may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 319a-e. The GRA may be configured to keep track of various settings, inputs, and parameters via database controllers.

The GRA database may communicate to and/or with other components in a component collection, including itself, and/or facilities of the like. Most frequently, the GRA database communicates with the GRA component, other program components, and/or the like. The database may contain, retain, and provide information regarding other nodes and data.

### The GRAs

The GRA component 335 is a stored program component that is executed by a CPU. In one embodiment, the GRA component incorporates any and/or all combinations of the aspects of the GRA that was discussed in the previous figures. As such, the GRA affects accessing, obtaining and the provision of information, services, transactions, and/or the like across various communications networks.

The GRA component enables the generation, sharing and interaction with collections of user-specified information resources, GRA matrices, and/or the like, the generation of dynamic and unique identifiers to represent terms and conditions of derivatives or other such financial instruments and subsequent trading on a standardized exchange using the obtained identifiers.

The GRA component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the GRA server employs a cryptographic server to encrypt and decrypt communications. The GRA component may communicate to and/or with other components in a component collection, including itself, and/or facilities of the like. Most frequently, the GRA component communicates with the GRA database, operating systems, other program components, and/or the like. The GRA may contain, communicate, generate, obtain, and/or provide program component, system, user, and/or data communications, requests, and/or responses.

### Distributed GRAs

The structure and/or operation of any of the GRA node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the GRA controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:

w3c−post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

### Experimental Results

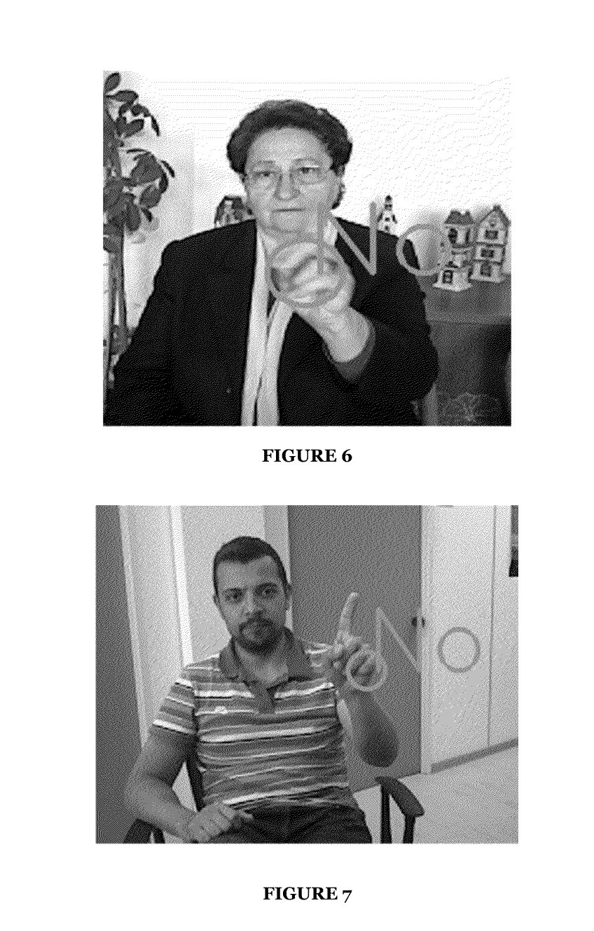

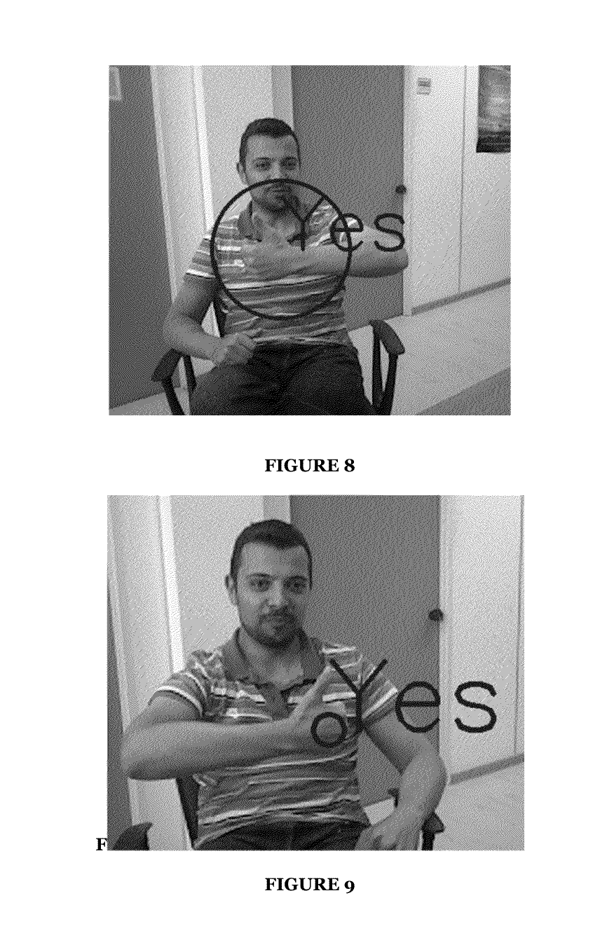

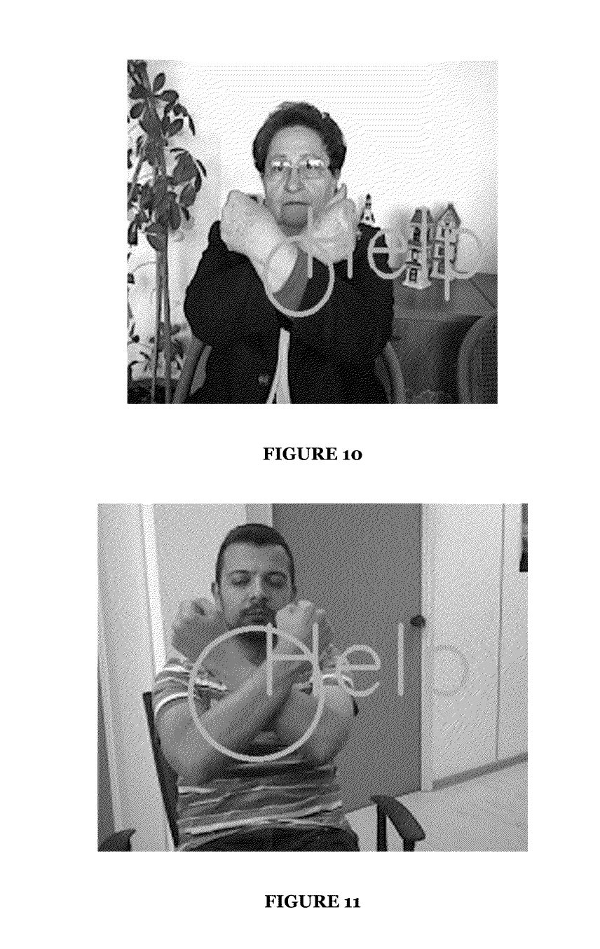

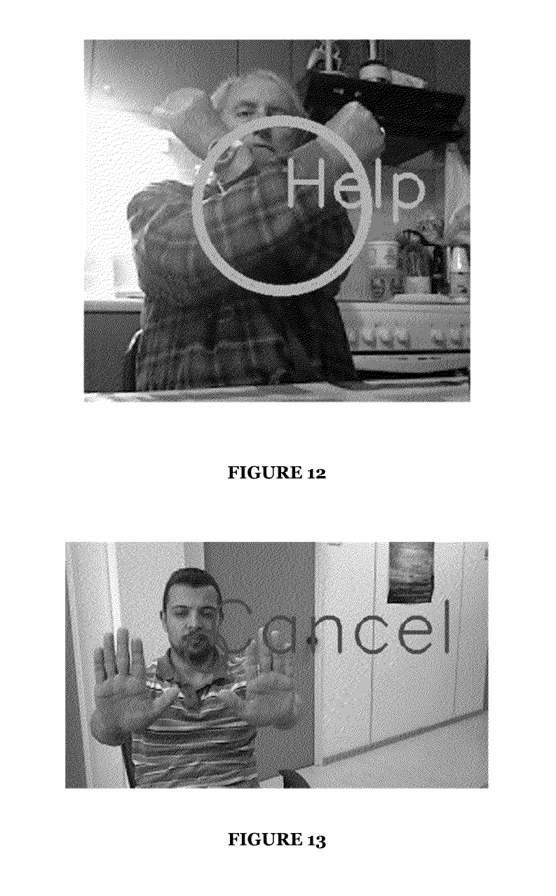

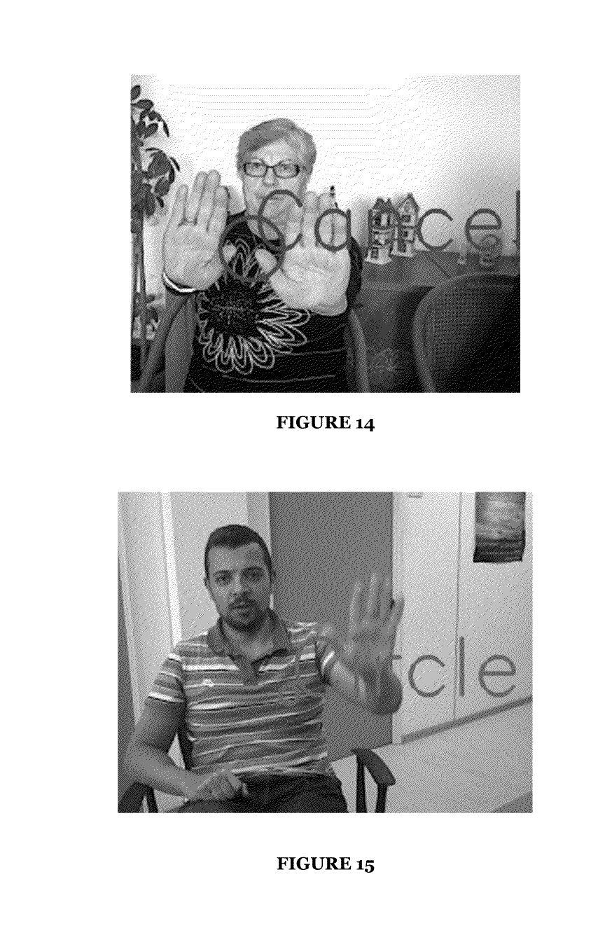

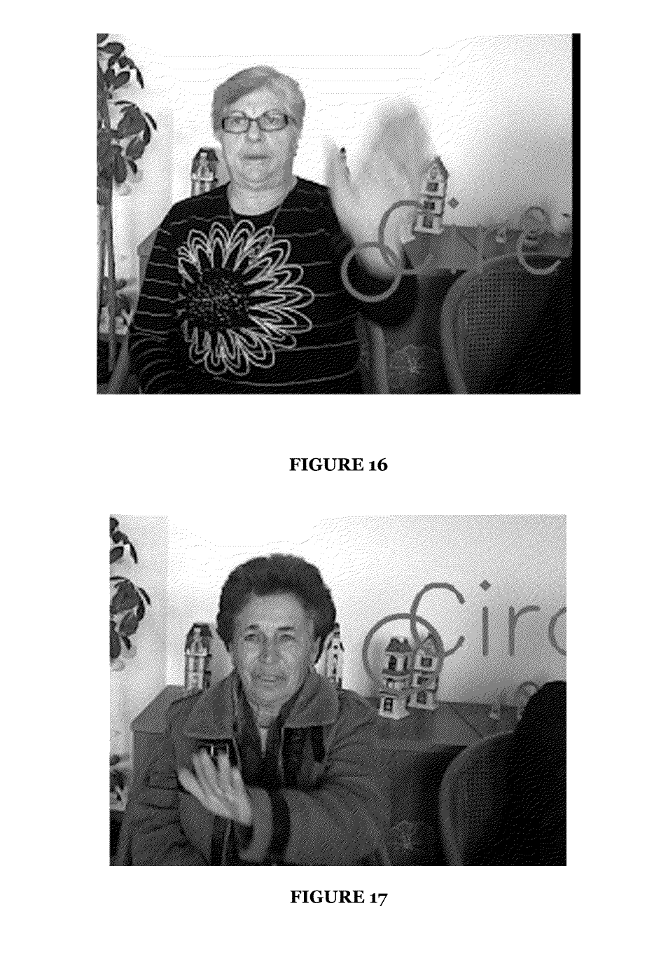

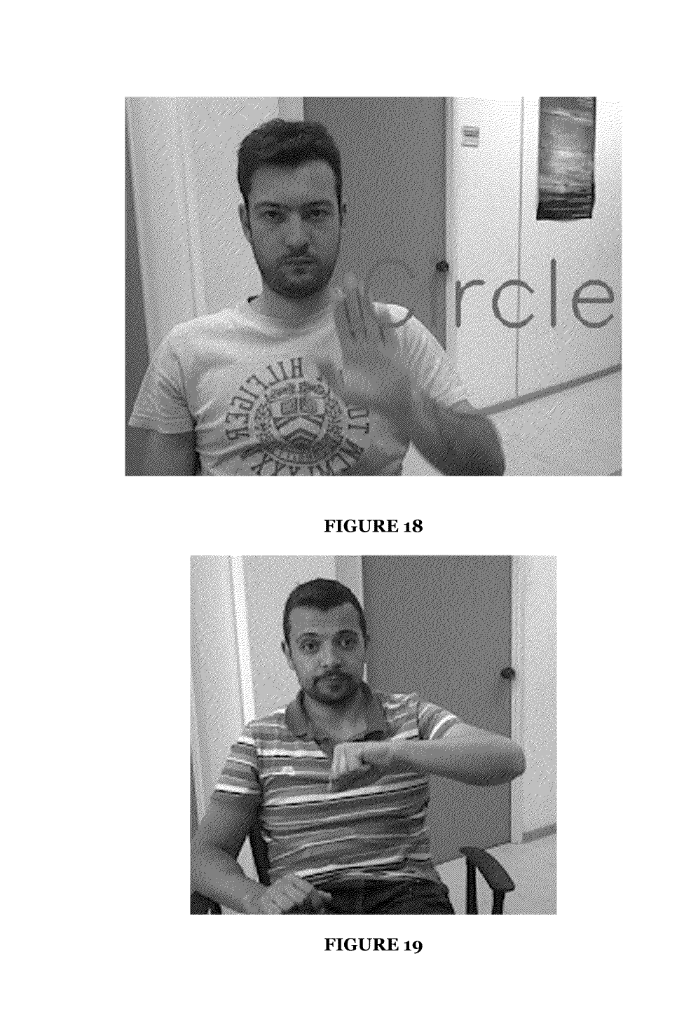

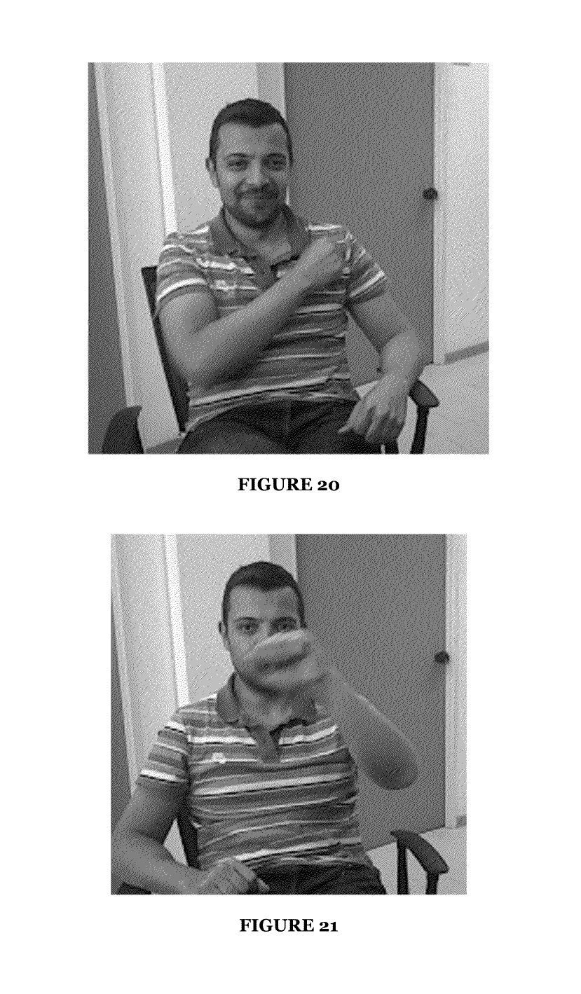

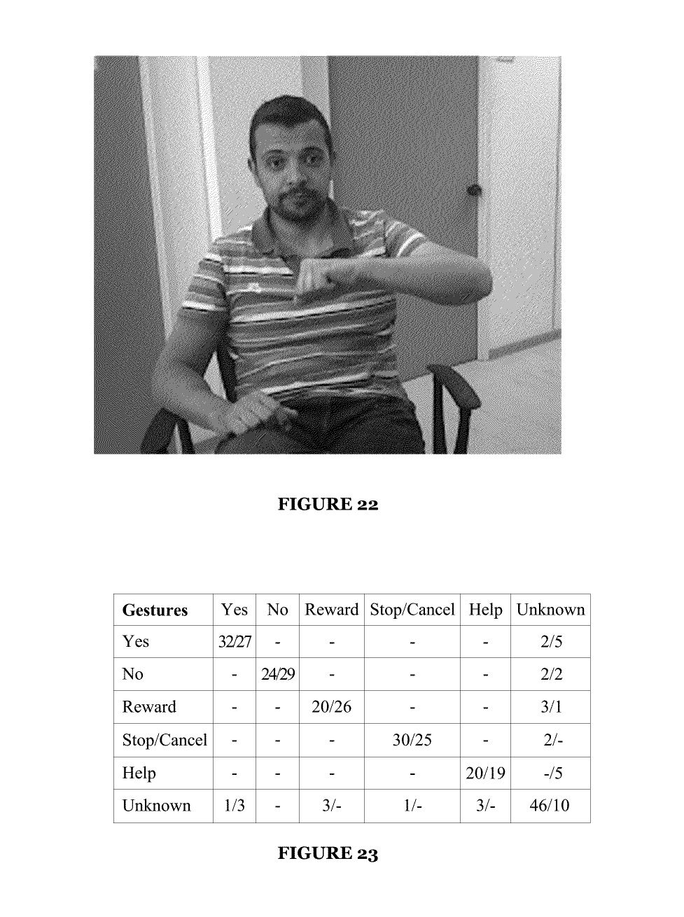

FIGS. 6-22 are an illustration of a series of screenshots showing experiments performed using GRA. In one implementation, to evaluate the gesture recognition methodology, two sets of user groups were identified that differed with respect to their age and to the their familiarity with technology. Furthermore, the groups use both the left and the right hand to perform the gesturing motions. Variations of gestures are also attempted. The gestures that are not defined in the GRA database, for example closed fist gestures, remain unrecognizable as shown in FIGS. 19-22. Some implementations allow for the user or a programmer to configure their own set of gestures.

In one implementation, to evaluate the gesture recognition methodology, two sets of user groups were identified that differed with respect to their age and to the their familiarity with technology. Intentionally, no member of the test group belongs to the group of subjects that participated in the definition of the gestural vocabulary.

Five persons from an academic/research environment participate in the first, experts group. A single example demonstration per gesture was performed to each subject explaining how to perform the gesture. A total of 189 gestures were performed by all subjects in the group, while 54 of them were unknown random gestures or intentionally performed unsupported gestures.

The second group of subjects consists of eight persons between 60-85 years old with practically no previous experience in technology. Each gesture was demonstrated a few times. Each of the five gestures were performed at least 3 times by each subject. In total, 156 gestures were performed by the second group and 13 out of them were irrelevant, random movements.

Regardless of the group, each subject was recorded in a single video where he performed the gestures at random order and without interruption. The 54+13=67 random movements or unsupported gestures that were intentionally or unintentionally performed by the test subjects were all assigned to the “unknown” class. The lack of response of the system to any of these un-modeled gestures was considered as a successful classification towards the “unknown” class. Therefore, the performance of the disclosed method is assessed in the presence of noise and irrelevant actions.

FIG. 23 shows the confusion matrices for the classification experiments for the two sets of users (experts/elderly). Actual class or ground truth appears in rows and the predicted class in columns.

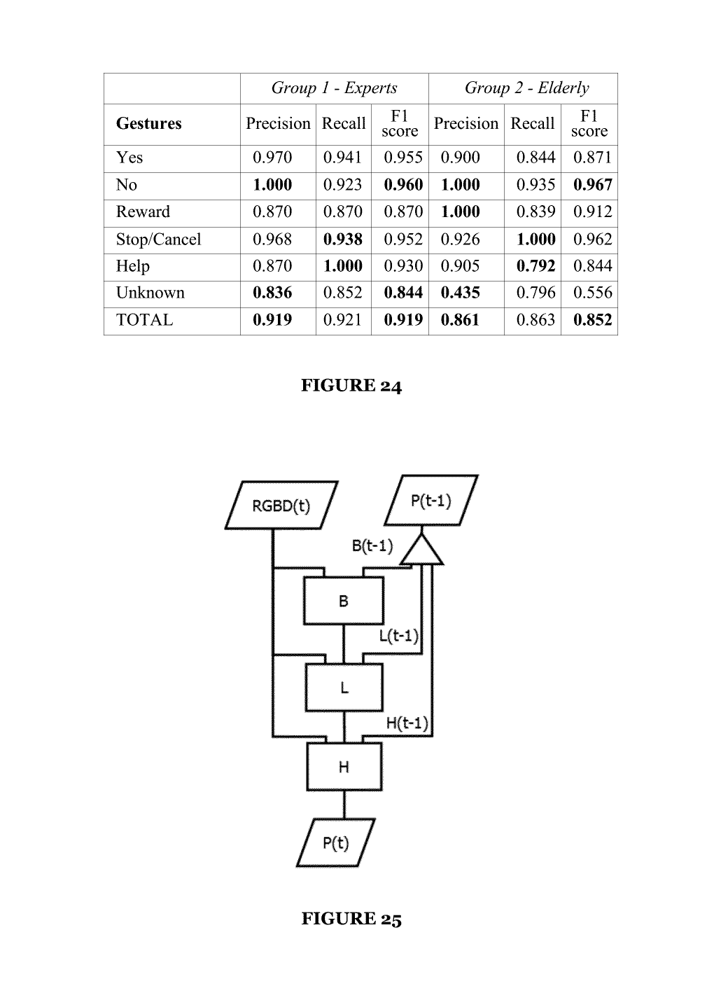

FIG. 24 reports the standard measures of statistical analysis for gesture classification. Precision, Recall and F- measure are reported for both test groups with respect to the set of the supported gestures.

For the group of experts, and excluding the “unknown” class, the precision, recall and F-measure metrics were never below 0.87. For the group of elderly, the minimum scores were 0.90, 0.792 and 0.844, respectively. The group of experts scored the lowest F-measure value for the “Reward” gesture. The qualitative analysis of the recordings showed that this happened because of the high speed of execution of the related circular hand motion. For the group of elderly, the lowest F-measure score appears at the “Help” gesture. This is because, for the elderly people, this appears still to be a hard/complex gesture, given the mobility constraints of some of the subjects. The qualitative analysis of the recordings showed that most of the elderly subjects performed this gesture by touching their arms on their torso, so depth discontinuities were not adequately estimated. The highest number of false positives and negatives was obtained for the “thumb up” gesture and for the group of the elderly. The requirement for a visible wrist-elbow during the execution of the gesture deteriorates the classification results for this group, as several subjects did not recall the relevant instructions while performing the gesture.

Overall, the performance of the system is satisfactory. As suggested by the results shown in FIG. 24, young experts perform better than elderly persons that are not familiar with technology. This is expected. Still, the relatively small difference in the performance of the two groups suggests that the disclosed approach is intuitive and can cover successfully the needs of a wide range of users.

In order to address various issues and improve over previous works, the application is directed to GESTURE RECOGNITION APPARATUSES, METHODS AND SYSTEMS FOR HUMAN-MACHINE INTERACTION. The entirety of this application (including the Cover Page, Title, Headings, Field, Related Art, Summary, Brief Description of the Drawings, Detailed Description, Claims, Abstract, Figures, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a GRA individual and/or enterprise user, database configuration and/or relational model, data type, data transmission and/or network framework, syntax structure, and/or the like, various embodiments of the GRA, may be implemented that enable a great deal of flexibility and customization. Furthermore, aspects of the GRA may be adapted for hand or leg gestures, and human-machine interaction in any field such as manufacturing, robotics, gaming, etc., and/or the like. While various embodiments and discussions of the GRA have been directed to certain embodiments, however, it is to be understood that the embodiments described herein may be readily configured and/or customized for a wide variety of other applications and/or implementations.

What is claimed is:

1. A processor-implemented method for gesture recognition, the method comprising:
receiving at least two temporally spaced RGBD frames depicting a gesture from a camera;
for each received frame, calculating a depth-based edge map based on comparing distances between adjacent pixel depth values in the received frame to a predetermined threshold distance;
for each received frame, producing a binary image map based on the depth-based edge map;
for each received frame, computing a skeleton of the binary image map;
for each received frame, analyzing the skeleton to identify at least one hand hypothesis; and
recognizing a gesture by comparing hand hypotheses identified for the at least two received frames.

2. The processor-implemented method for gesture recognition of claim 1, further comprising, for each received frame, computing a contour map based on the depth-based edge map, wherein the binary image map produced for each frame is produced based on the contour map.

3. The processor-implemented method for gesture recognition of claim 1, wherein analyzing the skeleton to identify hand hypotheses includes computing spanning trees from the skeleton and traversing the spanning tree from a leaf node toward another leaf node so long as a spanning tree node does not exceed a predetermined hand size threshold.

4. The processor-implemented method for gesture recognition of claim 1, wherein recognizing a gesture by comparing hand hypotheses includes identifying a hand posture from each of the hand hypotheses identified for the at least two received frames.

5. The processor-implemented method for gesture recognition of claim 4, wherein identifying a hand posture includes, for each identified hand hypothesis, identifying orientations of at least a wrist, an index finger, and a thumb of the hand hypothesis and comparing the identified orientations to a predetermined set of hand posture identification rules.

6. The processor-implemented method for gesture recognition of claim 1, wherein recognizing a gesture by comparing hand hypotheses includes, for each identified hand hypothesis, identifying the location of a palm center of the hand hypothesis.

7. The processor-implemented method for gesture recognition of claim 1, wherein recognizing a gesture by comparing hand hypotheses includes recognizing movement of a hand hypothesis from one received frame to another and comparing the recognized movement to a predetermined set of gesture movement rules.

8. A gesture recognition computing device comprising:
a processor;
a memory communicatively coupled to the processor, wherein the memory comprises,
a camera interface module, which, when executed by the processor, receives at least two temporally spaced RGBD frames depicting a gesture from a camera; and
a gesture recognition module, which, when executed by the processor, performs the steps of:
for each received frame, calculating a depth-based edge map based on comparing distances between adjacent pixel depth values in the received frame to a predetermined threshold distance;
for each received frame, producing a binary image map based on the depth-based edge map;
for each received frame, computing a skeleton of the binary image map;
for each received frame, analyzing the skeleton to identify at least one hand hypothesis; and
recognizing a gesture by comparing hand hypotheses identified for the at least two received frames.

9. The gesture recognition computing device of claim 8, wherein
the gesture recognition module, when executed by the processor, performs the further step of, for each received frame, computing a contour map based on the depth-based edge map; and
the binary image map produced for each frame is produced based on the contour map.

10. The gesture recognition computing device of claim 8, wherein analyzing the skeleton to identify hand hypotheses includes computing spanning trees from the skeleton and traversing the spanning tree from a leaf node toward another leaf node so long as a spanning tree node does not exceed a predetermined hand size threshold.

11. The gesture recognition computing device of claim 8, wherein recognizing a gesture by comparing hand hypotheses includes identifying a hand posture from each of the hand hypotheses identified for the at least two received frames.

12. The gesture recognition computing device of claim 11, wherein identifying hand posture includes, for each identified hand hypothesis, identifying orientations of at least a wrist, an index finger, and a thumb of the hand hypothesis and comparing the identified orientations to a predetermined set of hand posture identification rules.

13. The gesture recognition computing device of claim 8, wherein recognizing a gesture by comparing hand hypotheses includes, for each identified hand hypothesis, identifying the location of a palm center of the hand hypothesis.

14. The gesture recognition computing device of claim 8, wherein recognizing a gesture by comparing hand hypotheses includes recognizing movement of a hand hypothesis from one received frame to another and comparing the recognized movement to a predetermined set of gesture movement rules.
